(19) United States
(12) Patent Application Publication
(10) Pub. No.: US 2026/0117056 A1
(43) Pub. Date: Apr. 30, 2026

(54) PVC COMPOUND

(71) Applicants: JIANTAO YE, MONROVIA, CA (US); JINTIAN YE, MONROVIA, CA (US); ALEC YE, MONROVIA, CA (US)

(72) Inventors: JIANTAO YE, MONROVIA, CA (US); JINTIAN YE, MONROVIA, CA (US); ALEC YE, MONROVIA, CA (US)

(73) Assignee: Value Wholesaler D/B/A Value Windows and Doors, INC., MONROVIA, CA (US)

(21) Appl. No.: 18/929,455

(22) Filed: Oct. 28, 2024

(51) Int. Cl. C08L 27/24

(52) U.S. Cl. CPC C08L 27/24; C08L 2205/025; C08L 2205/035

(57) ABSTRACT

A PVC compound has by weight: 60% chlorinated polyvinyl chloride (CPVC); 15% unplasticized polyvinyl chloride (uPVC); 1.5% a first acrylic resin compound (ACR); 6% calcium carbonate (CaCO3); 1.8% an organotin stabilizer; 0.18% organic peroxide (OPE); 0.36% a process aid; 0.73% a lubricant, wherein the lubricant acts as a blowing agent; 10.8% chlorinated polyethylene (CPE); and 3% a second acrylic resin compound (ACR). The PVC has a Vicat softening temperature of the compound of 200° F. or higher. The compound is used as a substrate in co-extruded PVC profiles for windows and doors or extruded for applications including fences, decks, and siding. The CPE and ACR components enhance the impact resistance of the compound. The process aid is an internal lubricant such as a decanedioic acid oleic alcohol ester or stearyl phthalate. The blowing agent is a mineral oil.

### BACKGROUND OF THE INVENTION

In general, Chlorinated Polyvinyl Chloride, also known as perchloroethylene resin, is produced by various types of photochlorination processes. CPVC generally contains 60-72% chlorine, but in most cases it contains 66-68% chlorine. Resistant to most acids, alkalis, and salts. Therefore, it has very good chemical resistance and is significantly better than other plastics in terms of heat resistance. The production methods of CPVC can be divided into three types: solution method, aqueous suspension method and solid phase method. The CPVC chlorine atoms produced by the solution method are evenly distributed on the molecular chain, and the product has good solubility and is mainly used in the paint industry.

Chlorinated polyvinyl chloride (CPVC) is a chlorinated polymer of polyvinyl chloride, because it has a higher chlorine content than polyvinyl chloride, the chlorine content of CPVC used as a molded product is about 65-68%, which has greater tensile mechanical strength and greater density than polyvinyl chloride, especially CPVC material has a higher softening point or heat deflection temperature, and also has higher flame-retardant performance. However, CPVC also has properties such as low impact resistance, increased melt viscosity, and poor thermal stability of the melt, which bring unfavorable factors to processing, molding and use. When the content of chlorine in CPVC increases, the flexural strength and tensile strength of CPVC also increases, due to the different regularity of the structure in the molecule, the decrease in crystallinity increases the polarity of the molecular chain, so the glass transition temperature of CPVC increases, and the temperature can reach more than 160° C. The maximum temperature range of CPVC products is about 100° C., so reducing the glass transition temperature to more than 100° C. can be used without affecting the use, and at the same time, it is relatively easy to process. The flexural strength of CPVC is greatly improved compared with PVC, and the tensile strength, electrical properties, combustion performance, heat resistance, mechanical strength, and corrosion resistance are greatly improved compared with PVC, however with black color profiles is sunny hot parts of the world, selecting CPVC alone is not enough.

The production of co-extruded PVC profiles, particularly for window and door applications often utilizes uPVC as a substrate material. Traditional uPVC substrates, with a Vicat softening temperature of around 162° F., face significant challenges in high-temperature environments. For example, in Phoenix, AZ, where ambient temperatures can reach up to 110° F., black color profiles can experience a temperature rise to approximately 190° F. Under such conditions, traditional uPVC softens and loses structural integrity.

China's Jinhua Chemical (Group) Co., Ltd. and Shanghai Chlor-Alkali Chemical Co., Ltd. took the lead in developing CPVC synthesized by solution method in the 60s of the 20th century, and put it into production in the mid-60s. In the 70s, Anhui Provincial Chemical Research Institute carried out the development of aqueous phase production process and achieved certain results. In 1985, Wuxi Chemical Group Co., Ltd. began to carry out research on the production of CPVC by liquid phase suspension chlorination, and then built a 100 tons/year CPVC production line. Dongtai Tianteng Chemical Co., Ltd. and Weifang Xuye Plastic Materials Co., Ltd. have formed a certain CPVC production capacity. At present, most of the production of CPVC in China is carried out by slightly large-scale CPVC manufacturers using their original equipment and processes, using ordinary polymerization degree of PVC resin as raw materials. Although most of its processes use aqueous suspension method, the chlorine content of domestic CPVC can only be maintained at about 66%, if it exceeds 68%, the processing performance is weakened, while the chlorine content of foreign high-quality CPVC can reach 70-75%. In addition, due to the rough chlorination process in China, the low tensile strength, yield strength and flexural strength of CPVC materials have not been improved.

Some believe that PCVC material can contain up to two chlorine atoms in its building block, but no one has yet been able to make a polymer with a chlorine content of 70%. That is to say, the mixture of isomers that may form polyvinyl chloride can be represented by (1,0)(1,1)(1,2) after chlorination, and CPVC can be regarded as a copolymer of three monomers: vinyl chloride, vinylidene chloride, and 1,2-dichloroethylene, and can be represented by (1,0)(1,1)(1,2) respectively. The research work showed that the ratio of (1,0)(1,1)(1,2) isomers was measured by measuring the residual PVC in CPVC by the chlorine content determination method.

Nuclear magnetic resonance (NMR) is an important test method to study the structure of CPVC, and the NMR spectra of CPVC include chemical shift peaks of (—CH2-), (—CHCl-), (—CCl₂-), and (—CHCl-), (—CHl2).-) The chemical displacement region of the structural unit is more complex than that of PVC. The NMR spectra of CPVC are also different depending on the chlorination method. Komoroshi et al. found that with the increase of chlorination degree, the content of (-_{CHl2}-) structural unit decreased, the content of (—CHCl-) and (—CCl₂-) structural unit increased, and the molar content of (—CCl2-) structural unit increased with the increase of chlorination degree. The content ratio of (—CH2-) and (—CHCl-) structural units in the NMR spectrum is determined by the ratio of the peak intensities of the two structural units.

### 1.3.2 Performance of CPVC

The thermal stability of CPVC is poor, and the decomposition mechanism is similar to that of PVC, but because it has a higher chlorine content and thus increases the unstable structure, the removal rate of HCl from CVPC is faster under dynamic conditions, and there may be free HCl adsorbed during the chlorination process in CPVC resin particles, and the free HCl has a catalytic acceleration effect on the decomposition of CPVC resin. As a result, the thermal stability of CPVC resin is significantly worse than that of PVC resin.

### SUMMARY OF THE INVENTION

The present invention relates is a high-temperature high-performance PVC compound for co-extruded PVC profiles with enhanced Vicat softening temperature and impact resistance. The high-performance high-temperature PVC compound is designed specifically for use as a substrate in co-extruded PVC profiles. The compound features a Vicat softening temperature of 200° F. or higher, addressing the limitations of traditional uPVC in high-temperature environments. This allows black profiles to be used confidently in hot regions without the risk of softening.

The compound is also formulated to enhance impact resistance, making it suitable for various applications including fences, decks, and siding. The invention provides a reliable solution for modern architectural designs and meets the growing demand for durable black profiles.

To address heat resistance issues, a novel high-temperature PVC compound with an enhanced Vicat softening temperature of 200° F. or higher has been developed. This compound ensures that black co-extruded profiles maintain their shape and functionality even in extreme heat. Additionally, the compound improves impact resistance, making it suitable for various high-performance applications.

A PVC compound has by weight: 60% chlorinated polyvinyl chloride (CPVC); 15% unplasticized polyvinyl chloride (uPVC); 1.5% a first acrylic resin compound (ACR); 6% calcium carbonate (CaCO3); 1.8% an organotin stabilizer; 0.18% organic peroxide (OPE); 0.36% a process aid; 0.73% a lubricant, wherein the lubricant acts as a blowing agent; 10.8% chlorinated polyethylene (CPE); and 3% a second acrylic resin compound (ACR). The PVC has a Vicat softening temperature of the compound of 200° F. or higher. The compound is used as a substrate in co-extruded PVC profiles for windows and doors or extruded for applications including fences, decks, and siding. The CPE and ACR components enhance the impact resistance of the compound. The process aid is an internal lubricant such as a decanedioic acid oleic alcohol ester or stearyl phthalate. The blowing agent is a mineral oil.

### BRIEF DESCRIPTION OF THE DRAWINGS

FIG. 1 is a diagram showing a deck extrusion.

FIG. 2 is a diagram showing a window or door extrusion.

### DETAILED DESCRIPTION OF THE INVENTION

### Glossary

CPVC (Chlorinated Polyvinyl Chloride): 60% Provides enhanced thermal stability and contributes to the high Vicat softening temperature of 200° F. or higher.

uPVC (Unplasticized Polyvinyl Chloride): 15% Acts as a primary matrix material, contributing to the overall mechanical properties of the compound.

ACR (Acrylic Resin): 4.5% Improves surface properties and adds to the compound's durability, with 1.5% initially and an additional 3% for further enhancement.

CaCO3 (Calcium Carbonate): 6% Functions as a filler and extender to improve mechanical properties and reduce material costs.

Organotin (Stabilizer): 1.8% Provides stabilization against degradation from UV exposure and heat.

OPE (Organic Peroxide): 0.18% Used as a cross-linking agent to improve the overall strength and durability of the compound.

Stearyl Phthalate (Process Aid): 0.36% Facilitates the manufacturing process by improving the flow properties of the compound and is preferably G60 (TM) grade CAS #14117-96-5.

Lubricant (Blowing Agent): 0.73% Helps achieve the desired density and weight of the final product. The lubricant is preferably a mostly mineral oil such as lubricating grease containing highly-refined mineral oils and additives such as the highly refined mineral oil 218 blowing agent Shell Gadus S2 V220 2 (TM). This typically refers to a specific type of chemical blowing agent used to create a cellular structure within plastics. Blowing agents are substances that produce gas through a chemical reaction or physical process, creating bubbles or foam within the plastic material. This process reduces the density of the plastic, enhancing its thermal and acoustic insulation properties while also increasing its stiffness. Physical blowing agents include substances like hydrocarbons (e.g., pentane) and liquid CO2, which volatilize under heat to create gas bubbles. Chemical blowing agents include compounds like azodicarbonamide, which decompose under heat to release gases such as nitrogen, carbon dioxide, or ammonia.

CPE (Chlorinated Polyethylene): 10.8% Enhances impact resistance and flexibility, crucial for withstanding physical stresses and environmental conditions.

ACR (Acrylic Resin): 3% Further improves impact resistance and contributes to the compound's toughness and durability.

CPVC heat stabilizers are able to absorb HCl released in the early stages of degradation to prevent the occurrence of intrinsic autocatalytic reactions. The ideal CPVC stabilizer is a multifunctional substance of one or more complexes with the following properties:
(1) Absorption of HCl produced by CPVC degradation;
(2) substitution of unstable atoms in the molecular chain;
(3) inhibition of the formation and growth of unsaturated double bonds;
(4) Harmful residues that affect stability formed after the reaction of neutralizing heat stabilizers;
(5) It has good photostability;
(6) It does not react with other additives and is not polluted by sulfide;
(7) It has good compatibility with CPVC resin at processing temperature, does not migrate, has low volatility, does not spray frost, and is not easy to be precipitated by solvents such as water and oil;
(8) Non-toxic, tasteless, cheap, easy to process, does not change the inherent properties of CPVC resin, etc.

The Vicat softening temperature of CPVC resin is approximately 40° C. higher than that of PVC resin. The safe use temperature of PVC rigid products generally does not exceed 60° C., while CPVC hard products can be used for a long time in the range of 40-98 °C., and is one of the few polymers that can be used for a long time at higher temperature and greater pressure.

Since CPVC is prone to deHCl de-HCl reaction during processing, heat stabilizers should be considered in CPVC formulations. A complex composed of bisphenol A epoxy resin, cycloalkyl epoxide, alkylphenol and pentaerythritol can be used as a CPVC stabilizer, which is non-toxic and easy to process.

Calcium-magnesium hydroxide stabilizers can increase the heat deflection temperature of CPVC. Methylene or ethylene distearamide can increase the heat deflection temperature of CPVC by 10-15°C. The barium perchlorate composite stabilizer developed by Zhongyuan Chemical Industry Co., Ltd. can extend the thermal stability time of CPVC by 3-5 times. Li Liangbo et al. found that this method can significantly improve the thermal conductivity of the material, but reduce the mechanical properties of the material. United States CPVC co-mixed gold is made of poly α-methylstyrene (AMS) and styrene (St)-acrylonitrile (AN) copolymer, which has good processing performance and high heat deflection temperature. Mu Nanxiang et al. characterized the sequence structure of CPVC resin through solid-state nuclear magnetic resonance (NMR) and analyzed the formation mechanism of allyl chloride in CPVC resin, and concluded that with the decrease of allyl chloride content, the thermal stability of the resin became better and better. Song Qiusheng copolymerized three monomers, formaldehyde acrylate (MMA), AN and AMS, to obtain a ternary copolymerization modified resin with good compatibility with CPVC and high heat resistance.

A solvent method has a main process with a process of dissolving PVC resin in an organic solvent and then chlorinating it. When the organic solvent is vinyl dichloride, the concentration of PVC is very important. For example, chlorination of 12% PVC solution will cause more dehydrochlorination and degradation reactions, and the resulting CPVC contains about the same amount of 1, 1, 2-trichloroethylene unit and 1, 2-dichloroethylene. However, when the vinyl chloride solution of PVC with a chlorination concentration of 7% is chlorinated, the molecular chain undergoes less dehydrochlorination and degradation reactions, and the chlorination of PVC is more uniform, and CPVC is mainly composed of 1, 2-dichloroethylene units. PVC can also be dissolved in chlorobenzene, so under the condition that both initiators and accelerators are present, PVC in chlorobenzene solution can react with chlorine gas at 110-115 ° C. to achieve chlorination. The initiator usually uses azodiisobutyronitrile (AIBN), the accelerator can use p-chlorophenylthionamide dichloride, and thionyl dichloride can also be used to chlorinate PVC, and the microstructure of the chlorination product is like that when chlorinated with chlorine gas. Phosgene (COCl2) can also homogeneously chlorinate PVC, resulting in CPVC with good thermal stability. The CPVC prepared by this process can be thermally stable for 7 hours in the air at 180° C., heated in nitrogen at a rate of 2 ° C./min, and the temperature at which the dehydrochlorination reaction begins to occur is as high as 260.6° C. In the chlorine chlorination process with chlorobenzene as solvent, chlorine can be used to absorb the unreacted residual chlorine in the temperature range of −20-10 ° C., and then recover chlorine and chlorobenzene, thereby increasing the chlorine absorption rate, eliminating waste and avoiding environmental pollution.

### 1.4.2 Aqueous Suspension Chlorination

Chlorine can chlorinate PVC powders suspended in aqueous solutions, and the chlorination conversion rate is controlled by the diffusion of PVC, i.e., the chlorination rate in the PVC suspended particles. It has been proposed that the periodic illumination method can be used to obtain homogeneous CPVC chlorination. In order to achieve better diffusion of the polymer phase, early process conditions required the addition of a small amount of swelling agent, such as chloroform (CCl3) or carbon tetrachloride (CCl4), to the aqueous phase), ultraviolet light, or an oil-soluble acylperoxysulfonate can catalyze chlorination. Since the 1980s, the chlorination preparation process has been significantly improved, using pressure chlorination, no longer adding halogenated hydrocarbon swelling agents, and many improvement measures have been proposed to improve the thermal stability of CPVC products. For example, before chlorination, deoxidation is carried out under reduced pressure at 62° C. for 15 minutes, then chlorinated at 62° C. for 30 minutes, and then heated to less than 95° C., irradiated with ultraviolet light, and further reaction. The obtained CPVC can withstand the processing temperature of 224° C. for more than 12 minutes without dechlorination after being mixed with organotin stabilizer. The chlorination process can treat the concentration of 15%-30% PVC suspended aqueous solution, the chlorine pressure can be increased to 0.23MPa, and the PVC suspended particles can fully absorb the chlorine gas within 30 minutes, and then react with 1.8×104 W ultraviolet radiation, and continuously replenish the consumed chlorine gas to maintain a constant pressure, and the reaction temperature naturally rises to about 95° C. The molecular weight of PVC resin has an important impact on the quality of CPVC resin, especially the processing stability of the product, so it is required that the raw material PVC resin is loose as much as possible, the structural regularity is good, and the film is as thin as possible. The conversion rate of vinyl chloride will affect the thermal stability of CPVC, so the researchers carried out chlorination experiments with PVC suspension polymerization solutions with conversion rates of 42.9%, 51.2% and 67.9%, and obtained three CPVC resins with chlorine content of 66.2%, 66.0% and 66.2% respectively, with heat deflection temperatures of 112, 110 and 109° C., and thermal stability times of 180, 180 and 160 minutes in the oven, respectively. It shows that CPVC products synthesized from PVC with low vinyl chloride conversion rate have good heat resistance.

The use of octadecyl-3-(3,5-di-tert-butyl-4-hydroxyphenyl) propionate in the suspension polymerization formula of vinyl chloride can improve the heat resistance of CPVC, and the dispersant used for polymerization is polyvinyl alcohol, and the initiator is disec-butyl peroxide dicarbonate. Polymerization at 65° C. for 6 hours yields 65% vinyl chloride conversion. The obtained PVC suspension aqueous solution was chlorinated at 55° C. for 7 hours under ultraviolet light irradiation to obtain CPVC resin with a chlorine content of 67%, and the product began to decompose at 190° C. for about 180 minutes. However, the CPVC synthesized without the above ester stabilizers began to decompose at 190° C. for 120 minutes. The dispersant uses polyvinyl alcohol with a relative molecular mass of (5-4.80) million, and when the initiator uses tert-butyl neocaprate peroxide and 3,5,5-trimethylhexanoyl peroxide, the CPVC with a chlorine content of 64% is lighter in color and can withstand a processing temperature of 195° C. for 120 minutes. The process of producing CPVC is preferably an aqueous suspension method due to its simple production process and short production process time.

Solid PVC powder or granules are chlorinated in a fluidized bed in the presence of an initiator (ultraviolet or elemental fluorine) to obtain a heterogeneous CPVC product with a high glass transition temperature and good thermal stability. In an ebullating bed at 55° C., the chlorination of loose PVC particles with diluted chlorine gas can be achieved to obtain CPVC. The gas stream participating in the reaction is composed of a mixture of gas containing 50% chlorine, 0.75% fluorine and 49.25% nitrogen (volume fraction), and CPVC products with 64% chlorine content and 0.6% fluorine content can be obtained after 100 minutes of reaction. According to the performance requirements of the product, some free radical polymerization monomers can also be added in the chlorination process to realize the chlorination reaction and grafting reaction at the same time. Chlorination grafted to the side groups on the macromolecular chain of CPVC functionalizes CPVC, which can change the lipophilicity and hydrophilicity of CPVC, improve tensile strength and impact strength, improve thermal stability, Vicat softening temperature and reduce processing temperature.

A gas-solid phase stirring chlorination method can also produce CPVC by first performing a step of loading PVC raw materials into a stirring kettle to carry out chlorination reaction by thermal initiation. Considering reaction time, reaction temperature and chlorine flow rate on the chlorine content of CPVC products, a reaction temperature of 115° C., reaction time of 2 hours, and a chlorine flow rate of 500-550mL/min is the best reaction condition. A gas-solid phase fluidized bed method can produce CPVC with ultraviolet lamp and initiator reaction catalyst. The reaction temperature can be low to allow a continuous scalable production of CPVC. A fluidized bed reactor can include a light system, a heat exchanger, a particle fluidization system, an air intake system and a product discharge system, which realizes the entry of raw materials in the reactor and the discharge of products at the same time. The results show that a good reaction temperature is 50-110 °C, a good ultraviolet wavelength is 350-600nm, and a good oxygen content is more than 0.05%. Although the reaction temperature of CPVC produced by the fluidized bed method is low, and the scale-up production of CPVC by gas-solid phase method is realized, there are shortcomings such as the uneven chlorination of the product and the long reaction time.

A low-temperature plasma chlorination method can also produce CPVC. Plasma can play a role in rapid chlorination, shorten the reaction time and reduce the reaction temperature. The solid-phase method is to directly carry out the chlorination reaction under normal pressure in a dry state, which allows low equipment corrosion, high product purity, simple process flow, low amount of pollutants discharged, and low production cost. However, in the process of gas-solid phase chlorination reaction, the dissipation of reaction heat is a very acute problem, if the reaction temperature is not properly controlled, it is easy to suffer from sintering and discoloration of materials, and it may be difficult to control product quality.

The present invention compound composition has the following optimal formulation by weight, namely 60% CPVC (Chlorinated Polyvinyl Chloride); 15% uPVC (Unplasticized Polyvinyl Chloride); 1.5% ACR (Acrylic Resin); 6% CaCO3 (Calcium Carbonate); 1.8% Organotin (Stabilizer); 0.18% OPE (Organic Peroxide); 0.36% G60 (Process Aid); 0.73% 218 (Blowing Agent); and 10.8% CPE (Chlorinated Polyethylene); 3% ACR (Acrylic Resin). These amounts can vary by 20% of their optimal amounts during formulation. During production, the variation in range should be kept to within 0.1% of the same piece. Thus, an acceptable formulation would be a PVC compound having by weight: at least 48% chlorinated polyvinyl chloride (CPVC); at least 12% unplasticized polyvinyl chloride (uPVC); at least 1.2% a first acrylic resin compound (ACR); at least 4.8% calcium carbonate (CaCO3); at least 1.44% an organotin stabilizer; at least 0.144% organic peroxide (OPE); at least 0.288% a process aid; at least 0.584% a lubricant, wherein the lubricant acts as a blowing agent; at least 8.64% chlorinated polyethylene (CPE); and at least 2.4% a second acrylic resin compound (ACR).

The present invention compound is effective for extrusions for structures such as windows and doors where they are especially effective for black colored co-extruded profiles, providing thermal stability and impact resistance. The composition is also good for extrusions for structures such as fences, decks, and siding, where various outdoor applications where higher Vicat temperatures and impact resistance are required. The advantages of the present invention include enhanced thermal stability and impact resistance as well as versatility. With a Vicat softening temperature of 200° F. or higher, the compound maintains structural integrity even in extreme heat to allow use as an elongated structural member. The chlorinated polyethylene CPE and additional ACR acrylic resin enhance the compound's ability to withstand physical impacts thus making the present invention compound suitable for a range of applications, including fences, decks, siding, and the like.

Generally speaking, organic tin, lead and metal soap stabilizers are suitable for stabilizing the PVC resin. These stabilizers also have a certain stabilizing effect on CPVC, but the effect is better when some improvements are made to it. The present invention uses organotin stabilizers which may be used in sulfur-containing organotins and organotins laurate. For example, the combination of dialkyl maleic acid organotin and thiocinnamic acid, can react to form sulfur-based organotin in the stabilization process to improve the stabilization effect. Another combination is the combination of two sulfur-containing organotins, and epoxy resin, polyol and phosphite vinegar can also be added as the third component. In addition, the combination of chlorinated alkyl groups and sulfur-containing organotin compounds can be used to make the material have good thermal stability for up to 140 minutes at a temperature of 190° C.

For PVC, one main stabilizer is usually used at the same time as one or two completely different chemicals as co-stabilizers to form a composite stabilization system, so that it has a synergistic stabilization effect.

CPVC can also have a composite stabilization system with the main stabilizers commonly used being lead and organotin stabilizers. A suitable co-stabilizer can produce a synergistic effect. For example, a stable system can use bisphenol A-type epoxy resins, alkylphenols, cycloalkyl epoxides, and pentaerythritol. The advantage of this composite stabilization system is that it is non-toxic and conducive to processing and molding. CPVC hard products require a high heat deflection temperature, which can be achieved by using calcium and magnesium hydroxide as a stabilizer. The barium perchlorate composite stabilizer launched has excellent performance, which can prolong the thermal stability time of CPVC by 3-5 times. Also, methylene or ethylene distearphthalamide can increase the heat deflection temperature by 10-15 ° C. The alkali metal clostilate can also be used as a heat stabilizer for CPVC alone, and its effect is preferred over the corresponding butyltin stolate.

A key feature of the present invention is the addition of 1.5% by weight of a first acrylic resin compound, and then in a second step the addition of 3% by weight of a second acrylic resin compound. The first acrylic resin compound and the second acrylic resin compound are preferably different compositions. Preferably, the first acrylic resin compound has a lower or higher melting temperature and is more flowable or less flowable than the second acrylic resin compound. Preferably, the second acrylic resin compound has more impact resistance and is more rigid than the first acrylic resin compound.

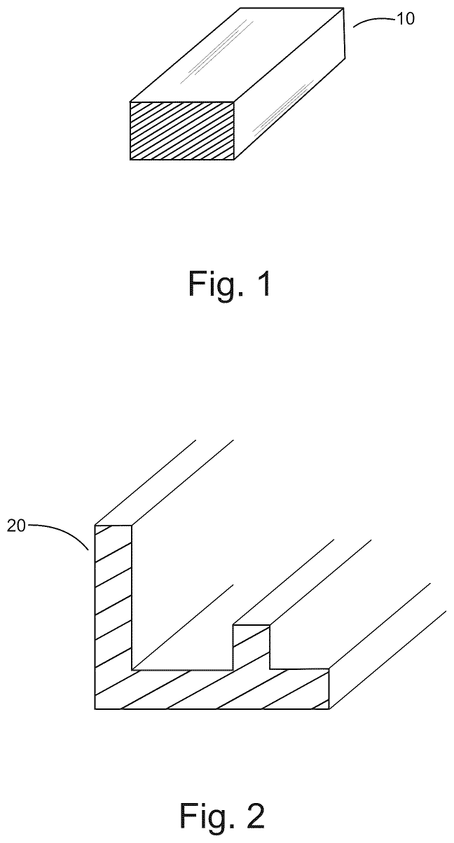

As seen in FIG. 1, a deck extrusion 10 can be made using the composition. As seen in FIG. 2, a window door extrusion can be made using the composition.

1. A PVC compound comprising the following by weight:
at least 48% chlorinated polyvinyl chloride (CPVC);
at least 12% unplasticized polyvinyl chloride (uPVC);
at least 1.2% a first acrylic resin compound (ACR);
at least 4.8% calcium carbonate (CaCO3);
at least 1.44% an organotin stabilizer;
at least 0.144% organic peroxide (OPE);
at least 0.288% a process aid;
at least 0.584% a lubricant, wherein the lubricant acts as a blowing agent;
at least 8.64% chlorinated polyethylene (CPE); and
at least 2.4% a second acrylic resin compound (ACR).

2. The PVC compound of claim 1, wherein the Vicat softening temperature of the compound is 200° F. or higher.

3. The PVC compound of claim 1, wherein the compound is used as a substrate in co-extruded PVC profiles for windows and doors.

4. The PVC compound of claim 1, wherein the compound is extruded for applications including fences, decks, and siding.

5. The PVC compound of claim 1, wherein the CPE and ACR components enhance the impact resistance of the compound.

6. The PVC compound of claim 1, wherein the process aid is an internal lubricant.

7. The PVC compound of claim 6, wherein the internal lubricant is a decanedioic acid oleic alcohol ester.

8. The PVC compound of claim 6, wherein the internal lubricant is stearyl phthalate.

9. The PVC compound of claim 1, wherein the blowing agent is a mineral oil.

10. The PVC compound of claim 9, wherein the Vicat softening temperature of the compound is 200° F. or higher.

11. The PVC compound of claim 9, wherein the compound is used as a substrate in co-extruded PVC profiles for windows and doors.

12. The PVC compound of claim 9, wherein the compound is extruded for applications including fences, decks, and siding.

13. The PVC compound of claim 9, wherein the CPE and ACR components enhance the impact resistance of the compound.

14. The PVC compound of claim 9, wherein the process aid is an internal lubricant.

15. The PVC compound of claim 14, wherein the internal lubricant is a decanedioic acid oleic alcohol ester.

16. The PVC compound of claim 14, wherein the internal lubricant is stearyl phthalate.

17. A PVC compound comprising the following by weight:
60% chlorinated polyvinyl chloride (CPVC);
15% unplasticized polyvinyl chloride (uPVC);
1.5% a first acrylic resin compound (ACR);
6% calcium carbonate (CaCO3);
1.8% an organotin stabilizer;
0.18% organic peroxide (OPE);
0.36% a process aid;
0.73% a lubricant, wherein the lubricant acts as a blowing agent;
10.8% chlorinated polyethylene (CPE); and
3% a second acrylic resin compound (ACR).

18. The PVC compound of claim 17, wherein the Vicat softening temperature of the compound is 200° F. or higher.

19. The PVC compound of claim 17, wherein the compound is used as a substrate in co-extruded PVC profiles for windows and doors.

20. The PVC compound of claim 17, wherein the compound is extruded for applications including fences, decks, and siding.
